(19) United States
(12) Patent Application Publication
(10) Pub. No.: US 2005/0166768 A1
(43) Pub. Date: Aug. 4, 2005

(54) Salad spinner dryer

(76) Inventors: David Porat, Newton, MA (US); Efrat Porat, Newton, MA (US)

Correspondence Address: GOTTLIEB RACKMAN & REISMAN PC, 270 MADISON AVENUE, 8TH FLOOR, NEW YORK, NY, 100160601, US

(21) Appl. No.: 11/032,926

(22) Filed: Jan. 11, 2005

Related U.S. Application Data
(60) Provisional application No. 60/541,098, filed on Feb. 2, 2004.

(51) Int. Cl. A23N 1/00

(52) U.S. Cl. 99/495

(57) ABSTRACT

A salad spinner dryer has a cylindrical drum into which the salad ingredients are placed that rotates about a horizontal axis at different rates and in different directions (e.g. clockwise and counterclockwise about the axis). Water thrown from the drum is collected. The different rates and directions of rotation are programmed from a control panel and assure that at some portion of the operating cycle of the dryer the salad ingredients tumble so as to separate the ingredients and avoid water trapping between ingredients adhered to each other by the water.

### PRIORITY

This application claims priority of U.S. provisional application Ser. No. 60/541,098, filed Feb. 2, 2004.

### FIELD OF THE INVENTION

The present invention relates to apparatus and methods for drying salad ingredients or other leafy materials by using centrifugal force to remove a liquid from the materials.

### BACKGROUND OF THE INVENTION

Salad ingredients have to be washed and dried before serving. This simple task has led to an unusually long history of attempts to solve the problem of removing all the water without destroying the ingredients. Various types of rotational schemes have been tried that use centrifugal forces to expel the water. They all suffer from a common defect, namely an inability to separate the leafy ingredients so that water does not remain trapped between leaves that are adhered by the water. The obvious concept of rotating the ingredients faster to provide greater centrifugal forces to remove the water is self defeating because it results in the leaves being pressed harder against each other and thereby making it less likely that the water trapped between the leaves will be expelled.

What is lacking in the prior art is a device that while spinning the ingredients causes them to tumble apart from each other so that the water which it is desired to expel is subjected to the centrifugal force engendered by the rotation without the leaves being compressed.

Among the prior attempts to solve the problem of water removal are noted the following United States patents: U.S. Patent No. 4,702,162 is a spinner dryer attachment for a food processor. It rotates the salad ingredients about a vertical axis at a rotation rate that is a fixed value reduced from the high speeds of a food processor. U.S. Pat. No. 5,156,084 is a hand driven vertical rotating food processor having a drainer basket. It too rotates about a vertical axis so that using a rotation rate that is low would cause the ingredients to fall to the bottom of the apparatus rather than to tumble. U.S. Pat. No. 5,562,025 is another device for spinning a salad about a vertical axis, thereby having the same defect with regard to an inability to allow the ingredients to tumble. U.S. Pat. No. 5,992,309 is yet another device for rotation about a vertical axis. U.S. Pat. No. 5,966,830 describes a device for rotation about a vertical axis that has inwardly sloping sides so that ingredients towards the bottom have a smaller rotation radius and therefor experience a lesser centrifugal force in order to protect delicate ingredients. This device cannot circulate the ingredients to experience both high and low centrifugal forces or allow tumbling. Indeed it is designed to keep the delicate ingredients away from high forces. U.S. Pat. No. 6,343,546 is another device rotating the ingredients about a vertical axis and therefore having the same defect as the previously described patented devices.

### BRIEF DESCRIPTION OF THE INVENTION

The invention is a salad spinner dryer that has a cylindrical drum into which the salad ingredients are placed. Here the term cylindrical is not limited to circular cylinders but may include cylinders having other cross sections, examples of which may be oval or rectangular. Circular cylinders are preferred. The drum rotates about a horizontal axis at different rates and in different directions (e.g. clockwise and counterclockwise about the axis). By horizontal is meant an axis that is preferably exactly horizontal but which may deviate from the horizontal by as much as 45 degrees. It definitely excludes a vertical axis. Water thrown from the drum is collected on an inner surface of a cover and collected in a tray at the bottom of the apparatus. The different rates and directions of rotation are programmed from a control panel. The rates and directions assure that at some portion of the operating cycle of the dryer the salad ingredients tumble so as to separate the ingredients and avoid water trapping between ingredients adhered to each other by the water.

### BRIEF DESCRIPTION OF THE DRAWINGS

FIG. 1 is a perspective drawing of a preferred embodiment of a salad spinner dryer of the present invention.

FIG. 2 is a section view of the apparatus of FIG. 1.

FIG. 3 is an end section view of the apparatus of FIG. 1.

FIG. 4 is a perspective view of the drum of the preferred embodiment of the salad spinner dryer of FIG. 1.

FIG. 5 is a front view drawing depicting the drum's door mechanism.

FIG. 6 is a system block diagram of the preferred embodiment of the present invention.

FIG. 7 depicts a drum drive assembly.

FIG. 8 depicts a removable drum assembly.

FIG. 9 depicts a removable drum.

FIG. 10 depicts an end view showing the door of a removable drum.

### DETAILED DESCRIPTION OF A PREFERRED EMBODIMENT

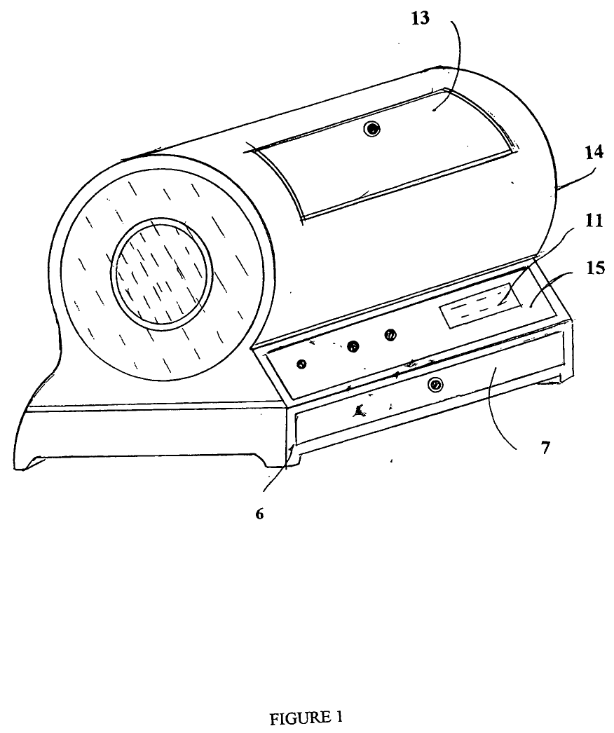

A preferred embodiment of the invention is depicted in the figures. As seen in FIG. 1, a salad spinner dryer is depicted having a body cover 14 of a generally horizontal cylindrical shape, having a main door 13 through which the salad ingredients may be inserted. Although the main door is depicted in the curved cylindrical surface, it is also possible to arrange the door to be in the flatter ends of the body cover. The body cover is supported upon a base that comprises a control panel 15 preferably having a keyboard/display 11, by which the operator of the salad spinner dryer has some control over the stages of the drying operation. Below the control panel there is a drawer member 6 giving access to a water collection tray Z.

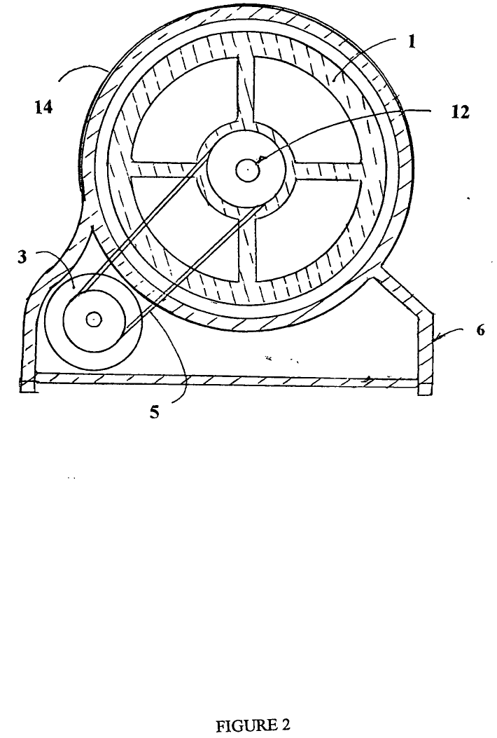

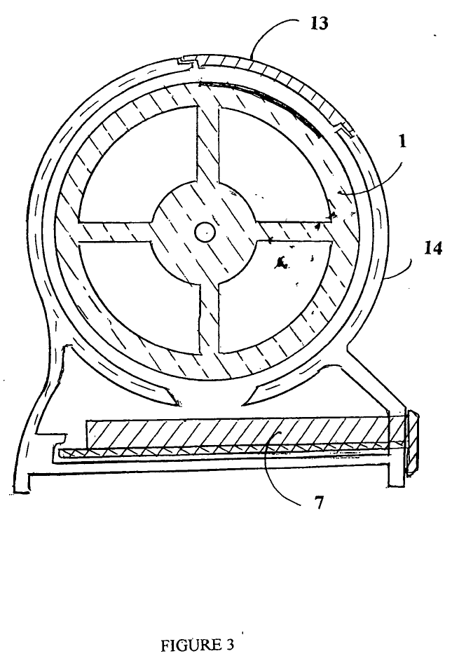

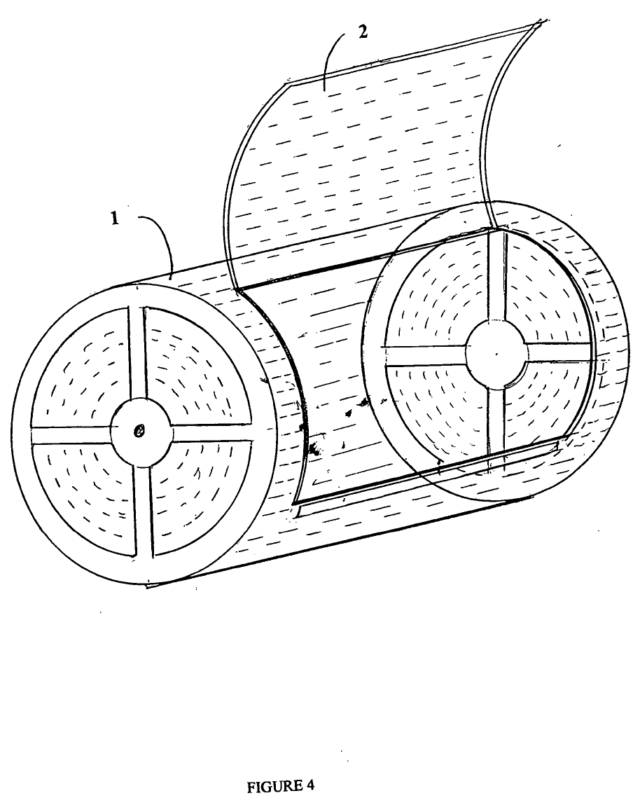

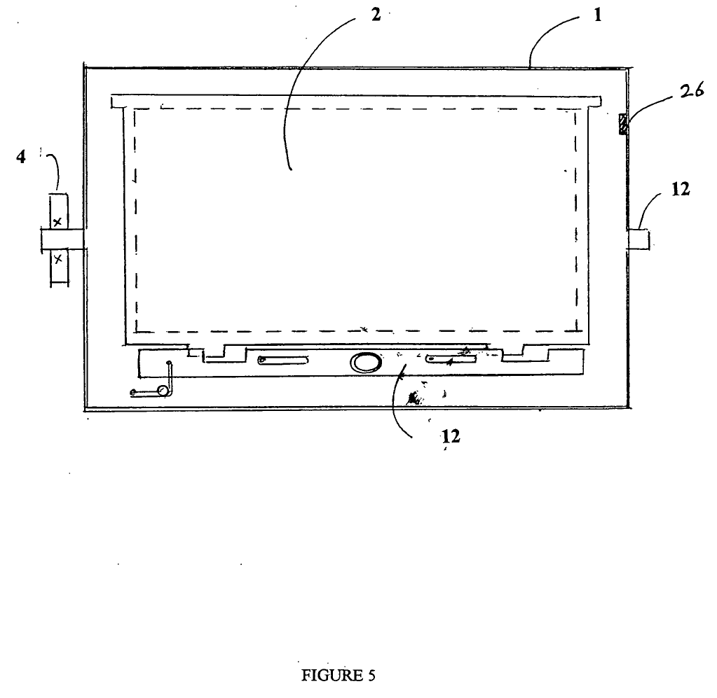

FIG. 2 is a section view of the apparatus of FIG. 1. Here it may be seen that the body cover 14 partially surrounds a cylindrical drum 1 made of a material that will pass water, such as a screen, or a wick material. The cylindrical drum 1 is supported on a horizontal axle 12 so that the drum may be spun about the axle. As shown in FIG. 4, doorway 2 in the drum may be aligned with main door 13 in the body cover 14 so that salad components can be introduced into the interior of the drum. To accomplish this alignment, a stop mechanism 26 as shown in FIG. 5, which may be any mechanism that engages a recess or protrusion in the drum to stop the drum in a position where the doorway in the drum is aligned with the main door 13.

When the drum rotates about its axle (which may rotate with the drum or be fixed with respect to the drum) the salad ingredients will experience a centrifugal force. If the rotational velocity is high enough this will cause water to move to the inner curved surface of the drum. The water will pass out of the drum where they will contact the inner surface of the body cover 14 and eventually flow downwards by gravity to be collected in the water collection tray 7.

FIG. 2 also shows a mechanism for rotating the drum 1. A gear motor 3 rotates a pulley that drives a belt 5, that in turn drives a sprocket 4 (see FIG. 5) connected to the drum 1 or its axle 12.

FIG. 4 depicts a view of the drum, in particular showing the doorway and door 2 for introducing the salad components into the drum, and for removing the salad contents after the drying operation is completed. The door of the body cover, may be secured by any convenient latching mechanism. The preferred embodiment is a sliding latch (not shown).

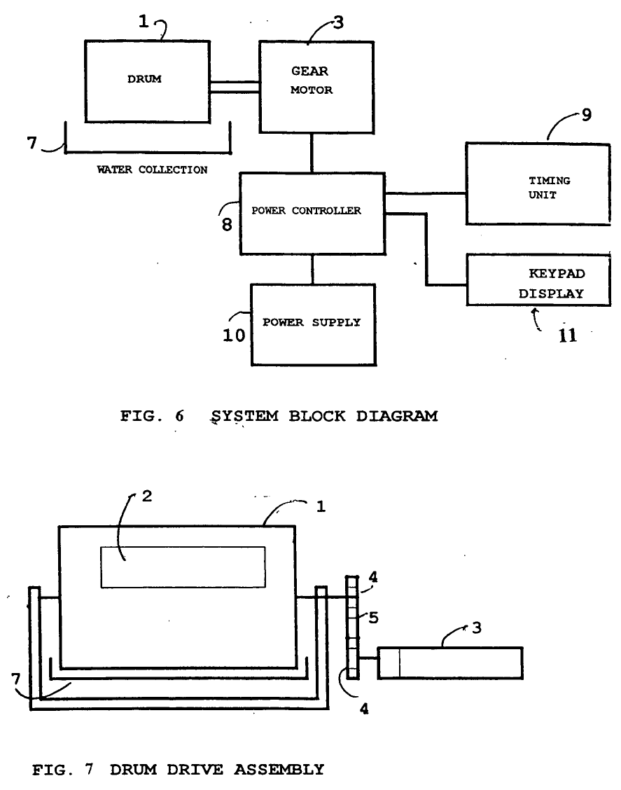

FIG. 6 is a system block diagram showing the interrelation of the drum and water collector with the gear motor and the power controller 8, which determines several parameters of the operation of the salad spinning dryer. In particular, by use of a keypad/display 11 and timer 9, the operator can select the timing of rotation velocity and direction of rotation to which the salad components are subjected.

The invention may be embodied in a system having the ability to subject the salad components to at least two different rotation rates and preferably, but not essentially, at least one change in direction (e.g. clockwise to counterclockwise) of rotation of the drum. The control of the motor rotation rates and rotation direction is accomplished by choices made at the control panel 15.

One of the problems of the prior art was that the rotation rate that forced the water from the salad components also kept the salad components pressed against each other thus limiting the amount of water that could be removed, The present invention employs a second slower speed or speed reversal during which the salad components tumble so as to loose this intimate contact and, when the rotation rate is again increased, allow more water to be removed. In order to further promote this tumbling the direction of rotation is reversible. During the reversal the components also tumble as is desired.

Although not preferred the system could operate with only one rotation rate, provided the direction of rotation is reversed from time to time, or slowed down enough to minimize the centrifugal forces holding the leaves together against the drum's wall.

The method of using the apparatus is as follows:

Beginning from a state in which the main door and the drum doorway are aligned, the salad ingredients are placed within the cylindrical drum. In an alternative embodiment the ingredients may enter the drum through a door in the end of the body cover that aligns with a door in the end of the cylindrical drum.

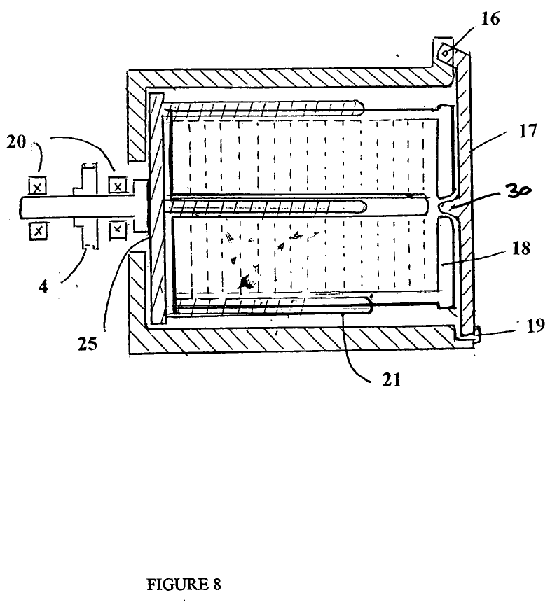

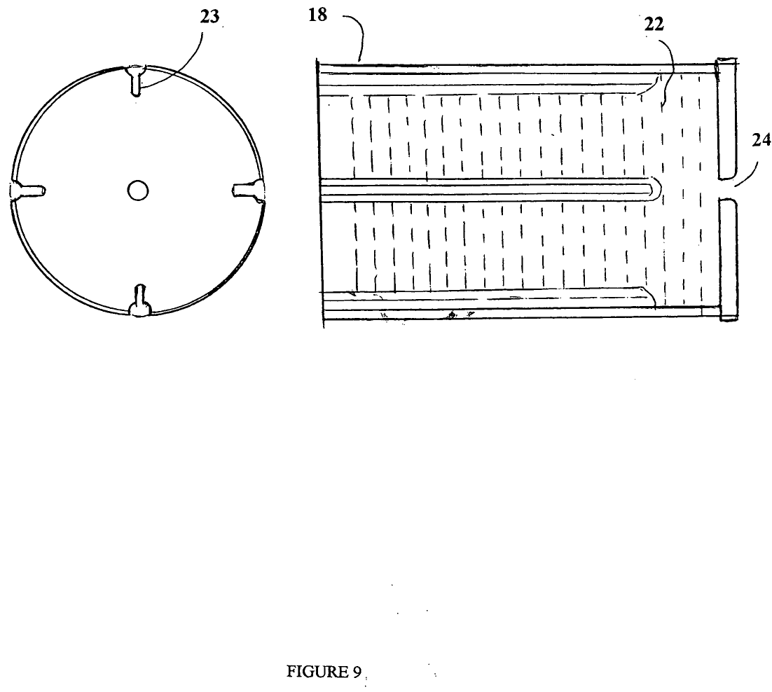

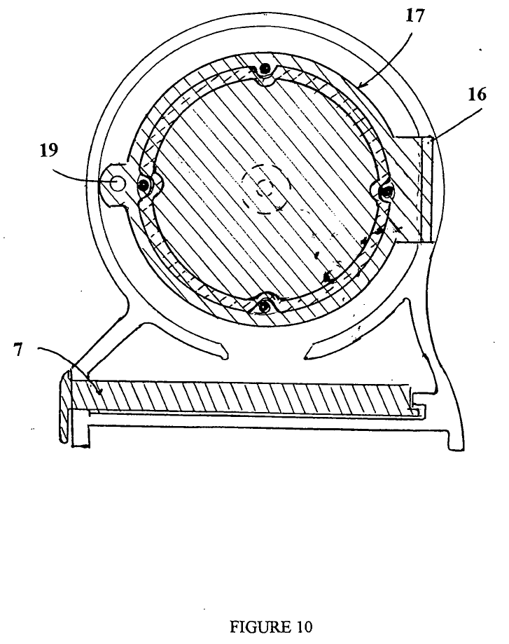

A second embodiment of the present invention has a removable drying drum used in conjunction with a side-loading door. A removable drum 18 of a cylindrical shape, with perforated or wicking wall 22 which has four longitudinal channels 23 is employed. The channels have two purposes: to engage the four driving pins 21, (see FIG. 8) and to act as internal mixing vanes to help in moving and mixing of the salad ingredients at low speeds.

The method of using this second embodiment is as follows:

The removable drum 18 is loaded with the salad ingredients and placed into the unit horizontally through an end door 17 having a guiding pin 30. When the end door 17 is closed, two functions are triggered: the drum engages into the door's guiding pin for additional support, and a safety lock 19 holds the door shut as long as the drum is rotating. The removable drum 18 is indexed into the four guiding pins 21 which in turn, are connected to the rotating plate 25 which is being supported by the two bearings 20 and being driven by the belt 5 and gear motor 3. Upon starting of the motor, the drum spins at various speeds, causing the water to be expelled due to the centrifugal forces at the elevated speeds, and to tumble and mix at low speeds. At the end of the cycle, when the drum is stopped, the end door may be opened, the removable drum pulled out and the dried salad ingredients removed.

Control functions are entered at the instrument panel to determine the cycle of operations of the invention. In particular the rotation rates, the frequency of direction reversal, and the length of the process may be programmed from the instrument panel.

The device is stopped in a state in which the main door and the drum doorway are aligned. The door and the doorway are opened and the salad ingredients removed.

In the second embodiment, the end door is opened, the removable drum is pulled out of the unit and loaded with the wet salad ingredients. The loaded drum is placed back into the machine and the door is closed. A run switch is depressed and the spinning cycle initiates. During the time of drum rotation, the end door is locked and cannot be opened. At the end of the drying cycle the end door is released and can be opened, the drum is pulled out and the dried salad ingredients are ready for use.

The collected water is then removed from the tray in which it was collected.

Although the invention has been described in terms of preferred embodiments it should be understood that the scope of the invention is that described in the following claims, together with structures equivalent to those recited.

1. A salad spinner dryer having a body cover and cylindrical drum contained within the body cover and driven by a motor,
said cylindrical drum having
a non-vertical axle supported by a frame and drivingly connected to said motor to enable the motor to cause rotation of the drum about the axle,
a doorway through which salad ingredients may be placed within the drum,
a surface of at least a portion of the drum that allows water to pass from the drum during rotation of the drum,
a body cover enclosing the drum and configured to enclose any water expelled from the drum,
a doorway in the body cover to allow placing salad ingredients through the doorway into the drum,
a water collector to receive water expelled from the drum,
a power controller to control the motor, and to determine rotation stages, comprising first and second rotation stages, such that the salad ingredients tumble during some portion of the operation of the salad spinner, and
a power supply for the motor.

2. The salad spinner dryer of claim 1, wherein the first rotation stage has a higher rate of rotation than the rate of rotation of the second rotation stage.

3. The salad spinner dryer of claim 1, wherein the first rotation stage has a different direction of rotation than the direction of rotation of the second rotation stage.

4. The salad spinner dryer of claim 1, wherein in addition to said first and second rotation stages there are additional rotation stages comprising a sequence of rotations at different rates and in different directions of rotation.

5. The salad spinner dryer of claim 4, wherein at least some of the rotation stages are selected from a control panel.

6. The salad spinner dryer of claim 1, wherein the doorway in the drum and the doorway in the body cover are located at one end of the drum and a corresponding end of the body cover.

7. The salad spinner dryer of claim 1, wherein the surface of the drum is made of a screen material through which water may pass.

8. The salad spinner dryer of claim 1, wherein the surface of the drum is made of material capable of wicking water through its surface.

9. The salad spinner dryer of claim 1 wherein the cylindrical drum is removable and has longitudinal indentations that engage a drive mechanism.

10. The salad spinner dryer of claim 9, wherein the longitudinal indentations extend into the interior of the cylindrical drum to form internal mixing vanes.

11. The salad spinner dryer of claim 1 having an end door that comprises a guiding pin, and wherein the drum engages the guiding pin.

12. The process of removing water from salad ingredients comprising
placing salad ingredients within a horizontal cylindrical drum,
determining a cycle of operations that varies the rotation rate and the frequency of direction reversal of the drum, such that the salad ingredients tumble during at least a part of the cycle of operations,
collecting water expelled from the salad ingredients on an internal surface of a body cover,
removing the salad ingredients,
removing the collected water.
